(19) United States
(12) Patent Application Publication
(10) Pub. No.: US 2022/0391797 A1
(43) Pub. Date: Dec. 8, 2022

(54) DISTRIBUTED PLATFORM FOR THE DEVELOPMENT OF ATTRACTING AND SCALING INNOVATION

(71) Applicants: Sustainable Growth Company, Inc., Toronto (CA); Prize Capital, LLC, Del Mar, CA (US)

(72) Inventors: Lee Stein, Del Mar, CA (US); Eric Beynon, Toronto (CA); Nathaniel Borenstein, Greenbush, MI (US)

(21) Appl. No.: 17/832,401

(22) Filed: Jun. 3, 2022

Related U.S. Application Data
(60) Provisional application No. 63/197,353, filed on Jun. 5, 2021.

(51) Int. Cl. G06Q 10/06; G06Q 10/08

(52) U.S. Cl. CPC G06Q 10/0637; G06Q 10/08; G06Q 10/06313; G06Q 10/06315

(57) ABSTRACT

Example implementations are described for a secure distributed system/platform for facilitating division of a collaborative efforts between a plurality of entities into various future obligations and potential rewards and for processing such obligations and rewards into a binding forward purchase agreement. The obligation and rewards of such Forward Purchase Agreement may be sectioned, codified, and implemented as a smart contract in, for example, a distributed ledger system. In some specific applications, a secure distributed collaboration system is disclosed for investors to promote development of a new technology solution for the future using forward purchasing agreement without having to know exactly which innovators will succeed in creating and demonstrating practicability in that technology space.

### RELATED APPLICATIONS

The present application claims the benefit of the filing date under 35 U.S.C. § 119(e) of Provisional U.S. Patent Application Ser. No. 63/197,353, filed Jun. 5, 2021, the entire content of which is hereby incorporated by reference.

### FIELD OF THE TECHNOLOGY

The present disclosure relates to methods and systems for facilitating development of attracting and scaling innovation using a secure distributed data processing platform.

### BACKGROUND

In general, many early stage major technological inventions are difficult to finance and take a long and complex track from the date of the first idea to later becoming a widely available product or service. In traditional financing scenarios of innovations, often funding is not provided until after a new innovation demonstrates convincing displays of practicability. This makes large scale development of an innovation more difficult, as it requires the innovation to be practically demonstrated prior to the financing. The development costs of such innovations may be high, and without an established market, can create financial risk for innovators. This can inhibit innovators from entering the market in the first place. Additionally, financing an innovation early involves significant risk limiting the cohort of potential investors, as there is no certainty that the practicability of the innovation will ever be demonstrated or that a market for the innovation will emerge.

The innovation process itself is often inefficient, with inventors first innovating and then searching for a problem and market to apply their innovation against. Start-up businesses desire a marketplace and buyers for their product or service in order to drive their growth; however, for many new innovations, no market exists. This creates a scenario where start-up companies spend resources chasing different applications of their technology in order to find purchasers, increasing their time to market and hindering their ability to access investment capital as having a customer is often a requirement to access early-stage investment.

In the meanwhile, the world requires dramatic and rapid new technological solutions to address its environmental, social and economic sustainability challenges, including climate change. The United Nations Sustainable Development Goals, the objectives of the Paris Climate Accord and other sustainability targets likely will not be achieved through moderate or incremental advancements alone. Innovation breakthroughs are required; however, innovation is difficult to plan for as it can't be scheduled and frequently emerges from unlikely places, making it difficult to tap into. An open innovation approach that clarifies a problem to solve and provides a specific target for innovators can solicit solutions from many innovators.

Historical capital market mechanisms are not typically structured to generate a broad suite of innovation required to address many of these global challenges, such as climate change, or to establish markets for innovations to help them commercialize. Incentive prize competitions have sometimes been used to catalyze innovation by opening up the participation to non-traditional developers. However, prize competitions typically only incentivize the development of an innovation, without a plan for scale or full commercial implementation, and without providing early stage capital to the development of the solutions by competitors. Additionally, many current capital market systems do not support prize competitions as these systems typically seek to risk capital without an assurance that an innovation will return both the capital investment along with a profit.

Many corporations desire innovations that can deliver step-change advancements to their businesses and, in particular, help them address publicly declared climate and sustainability objectives. They are under increasing pressure from shareholders and stakeholders such as employees, customers and governments, to deliver sustainability solutions. However, many companies are unable to pursue breakthrough innovation due to corporate culture, operational demands taking precedence and constraints on capital use. Financial structures often demand that corporations allocate capital to existing business or returned to shareholders as opposed to speculated on new, unproven ventures. An ‘open innovation’ approach can mobilize solutions outside of the company, however there is a challenge of appropriately financing the innovations that emerge so that they can succeed and achieve scale.

It is thus desirable to enable/facilitate the innovation path by designing a platform for simultaneously arranging for both the later stage scaling, and commercial implementation of innovations in parallel with the search for the innovation itself. For innovation at scale, it is essential to engage more traditional capital market investment while enabling sensitive and proprietary information and protecting legal rights of various parties via advanced technological components.

### SUMMARY

As described in greater detail below, example implementations are described for a secure distributed system/platform for facilitating division of collaborative efforts between a plurality of entities into various future obligations and potential rewards and for processing such obligations and rewards into a binding forward purchase agreement. The obligation and rewards of such Forward Purchase Agreement may be sectioned, codified, and implemented as a smart contract in, for example, a distributed leger system. In some specific applications, a secure distributed collaboration system is disclosed for investors to promote development of a new technology solution for the future using forward purchasing agreement without having to know exactly which innovators will succeed in creating and demonstrating practicability in that technology space.

### BRIEF DESCRIPTION OF THE DRAWINGS

FIG. 1 is a block diagram illustrating an overview of a data flow in a system for the development of attracting and scaling innovation of the example(s) provided herein.

FIG. 2 is a flow diagram illustrating the process of developing, attracting, and scaling an innovation through the system of FIG. 1.

FIG. 3 illustrates an example secure distributed ledger system.

FIG. 4 shows an example of computing component that can be used in the systems of FIG. 1 and FIG. 3.

### DETAILED DESCRIPTION OF THE EMBODIMENTS

This disclosure describes example implementations of a secure distributed system/platform for facilitating division of a collaborative efforts between a plurality of entities into various future obligations and potential rewards and for processing such obligations and rewards into a binding Forward Purchase Agreement (i.e., an “Advanced Market Commitment”) including a customer for an innovation solution structurally tied to project financing and innovation seed funding. The Advanced Market Commitment is also simultaneously tied to project finance which historically has been limited to defined engineered construction. While the various embodiments below are described in the context of technological innovation harvesting, financing, incubation, and commercialization, the underlying principles are applicable to other collaborative contexts involving multiple parties and interdependences where obligations, rewards, and risk can be defined in future but difficult to specify at a current time.

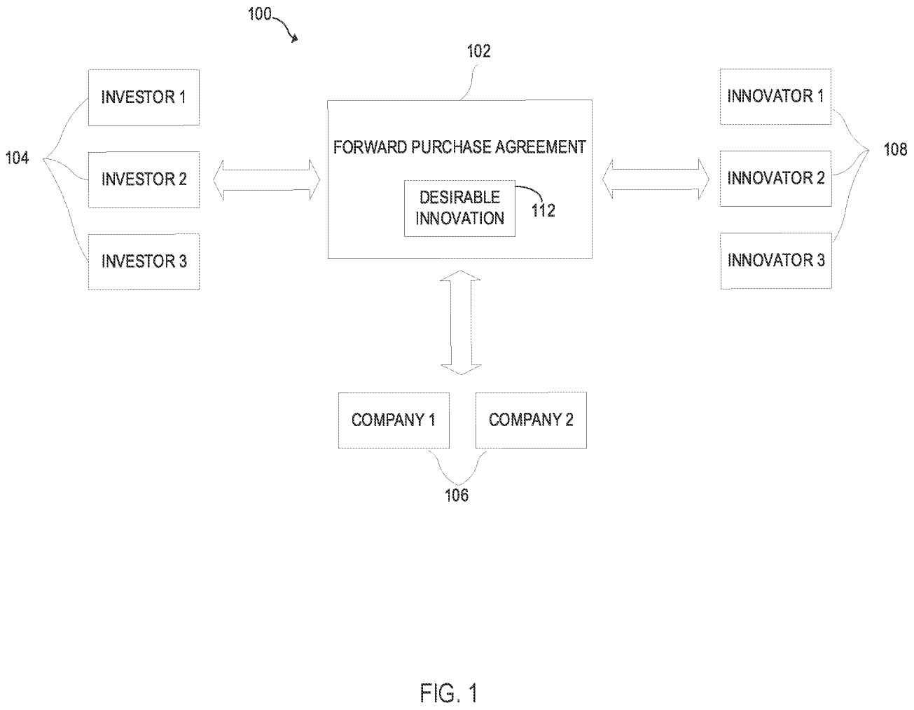

FIG. 1 illustrates an example overview organizational structure and data flow 100 of an underlying advance-market commitment system (also referred to as 100) for the development of attracting and scaling innovation. The advance-market commitment system underlying the data flow 100 may bring together various stakeholders, including but not limited to one or more investors 104, one or more innovation-seeking entities/organizations 106, and one or more innovators 108. These various stakeholders in the advance-market commitment system may be brought together based on a Forward Purchase Agreement 102. The Forward Purchase Agreement may be focused on conceptualizing, selecting, financing, developing, and commercialization of a particular desirable innovation 112 by the innovation-seeking entities/organizations 106. The innovation-seeking entities/organizations 106 are herein alternatively referred to as “companies” 106.

The advance market commitment system 100 allows various stakeholders, including the investors 104 and the companies 106, who wish to promote the development of a new technology solution to invest money in the future of a particular industry without knowledge about which particular innovator 108 they want to invest in, or which particular innovator 108 may succeed in creating a new, desirable technology pertinent to the desirable innovation 112. In doing so, the advance market commitment system 100 may enable a future marketplace for desirable innovation 112 at a current time.

The advance market commitment system 100 may be managed by an optional managing entity, separate from the other stakeholders, including the investors 104, the companies 106, and the innovators 108. The optional managing entity may control the drafting and issuance of the Forward Purchase Agreement 102, evaluate submissions of the desirable innovation 112, and perform other administrative tasks required of the advance market commitment system 100. The optional managing entity may provide support to attract investors 104, companies 106, and/or innovators 108. The optional managing entity may develop a marketplace for the desirable innovation 112 to enable managing and awarding the Forward Purchase Agreement 102. This marketplace may be implemented using an online platform. The online platform can permit the various stakeholders to view and evaluate the Forward Purchase Agreement 102. The managing entity may also provide assistance to the various stakeholders, including investment assistance, technological assistance, and/or marketing assistance.

In the organizational structure and data flow described herein, the Forward Purchase Agreement 102 forms the basis of the advance market commitment system 100. Accordingly, the Forward Purchase Agreement 102 forms the basis of the relationship between the various stakeholders, including investors 104, companies 106, and innovators 108.

Investors 104 may be, for example, individuals, families, partnerships, endowments, foundations, governments, private or public companies, and/or universities. Investors 104 may also be referred to as investing entities. Different investors 104 may choose to provide logistic and financial support to different forward contracts 102 for various reasons, such as return on investment, diversification or mitigation of risk opportunities, or specific philanthropic goals, and to support in different ways including through provision of venture investment directly to innovators 104 or through project financing that is committed to in advance (e.g., Bridge Project Finance) to support the Forward Purchase Agreement 102. For example, an investor may have already chosen to financially support multiple forward purchase agreements 102 within an area related to, e.g., rare disease medicines, and then choose to financially support a Forward Purchase Agreement 102 in a different industry in order to mitigate their investment risk. As another example, an investor 104 might choose to finance a certain Forward Purchase Agreement 102 because of a particular philanthropic objective of the investor 104. For another example, a first investor 104 might have a particular goal of promoting renewable energy, and might seek to financially support a Forward Purchase Agreement 102 in that particular industry, while a second investor 104 might have a particular goal of promoting low-cost water purification methods for remote locations, and thus might seek to financially support a Forward Purchase Agreement 102 in the water purification industry.

Investors 104 may provide venture funding directly to innovators 108. In such examples, investors 104 may provide logistic and financial support to a particular innovator during the innovation period, enabling the innovator to utilize resources while seeking to develop the desirable innovation 112. Investors 104 may also provide financing to back Forward Purchase Agreement 102. In such examples, investors 104 do not provide logistic and financial support to a particular entity, but instead to the Forward Purchase Agreement 102, which may be provided after an innovator develops an innovation meeting the set of criteria of desirable innovation 112. Investors 104 may also provide funding both directly to innovators 108 and to the backing of Forward Purchase Agreement 102. Providing funding both directly to innovators 108 and to the backing of Forward Purchase Agreement 102 may help promote the development of the desirable innovation 112.

The companies 106 may be, for example, start-up companies, joint ventures, established public and private corporations, universities, and the like. The companies 106 may also be referred to as commercialization entities.

The innovators 108 may be, for example, individual inventors, groups of inventors, start-up companies, joint ventures, universities, and established public and private companies.

The terms for the various stakeholders in the forward purchase agreement, i.e., the investors 104, the companies 106, and the innovators 108, are intended to convey the general nature of the relationship to the Forward Purchase Agreement 102, rather than the identity or nature of the entity and/or person itself. Thus, in some examples, an entity may be considered company 106 to a first Forward Purchase Agreement 102, but innovator 108 to a second Forward Purchase Agreement 102. Similarly, an entity may be considered innovator 108 to a first Forward Purchase Agreement 102, but investor 104 to a second forward purchase agreement. A single stakeholder may have different roles in two different forward purchase agreements 102.

As described previously, the core of the advance market system 100 is the Forward Purchase Agreement 102. In some examples, Forward Purchase Agreement 102 may be an advance market commitment. An advance market commitment is generally a binding contract offered by a financing entity that is used to guarantee a defined market for a new, desired technology, once the desired technology is developed and practicability is demonstrated. Advance market commitments have been used, for example, to incentivize the development of vaccines or other medicines that have high up-front development costs.

In some examples, Forward Purchase Agreement 102 may be a forward contract. A forward contract is generally an agreement to buy an asset at a fixed price at a future time. As one example, the asset may be energy (e.g., electric power) and a corresponding Forward Purchase Agreement 102 may be a future energy purchase agreement. Such a power purchase agreement represents a common contract structure used in the power sector for future energy supply. A utility company may offer to purchase all of the power generated by a specific project or plant, typically from a renewable energy source, such as solar cells, at a specified price for a specified term in the future, before the project is built. This creates a guaranteed market, which may then attract a company to develop a plan for the power generation project and to sell energy in advance to utility service providers under the power purchase agreement(s). This then may permit low-cost financing of the power generation project. With the guaranteed market, this may attract investors to help fund the company in developing, e.g., solar array systems or farms, since there is a likely a possible return on investment.

In some examples, Forward Purchase Agreement 102 may be implemented in the form of an offtake agreement. An offtake agreement may be made between a producer and a buyer to purchase or sell portions of future-products. Thus, in the advance market commitment system 100, the company 106 may choose to purchase portions or all of future-products by innovator 108 as part of the Forward Purchase Agreement 102.

Forward Purchase Agreement 102 may also be referred to as an impact purchase agreement. An impact purchase agreement may represent a future purchase commitment that is made subject to the invention of a technology or solution that meets a desired set of criteria. In advance market commitment system 100, the impact purchase agreement may accordingly be a future purchase commitment for the innovation together with project financing for the development and/or deployment of the desirable innovation 112.

The Forward Purchase Agreement 102 may be structured in various ways to incentivize development of technologies, in particular, the desirable innovation 112. In some examples, through Forward Purchase Agreement 102, company 106 may contractually agree to purchase the intellectual property rights associated with the desirable innovation 112 developed by innovator 108 that meets the specified criteria defined by the Forward Purchase Agreement 102. In some examples, through Forward Purchase Agreement 102, company 108 may contractually agree to purchase any and/or all goods or services produced by innovator 108 that meets the specified criteria defined by Forward Purchase Agreement 102. In some examples, company 108 may contractually agree, through Forward Purchase Agreement 102, to provide resources to commercially develop and/or scale the good or service developed by innovator 108. Additionally, Forward Purchase Agreement 102 may include a project plan and/or financial incentives for the desirable innovation 112 to incentivize development by innovators 108.

In some examples, multiple forward purchase agreements 102 may be managed by the advance market commitment system 100 across various industries, or within different sectors of an industry. This may permit a given Forward Purchase Agreement 102 to cover a different innovation vertical, i.e., a different market sector. In some examples, multiple forward purchase agreements 102 may be awarded to multiple innovations in order to promote a suite of new technologies.

Forward Purchase Agreement 102 may include a wide variety of general contract provisions detailing the terms of the agreement. Forward Purchase Agreement 102 may include specific provisions regarding the term of the Forward Purchase Agreement 102. For example, Forward Purchase Agreement 102 may detail the period of time that submissions for innovations meeting the set of criteria of desirable innovation 112 may be accepted. Forward Purchase Agreement 102 may also include terms about the length of any relationship between company 106, innovator 108 and/or investor 104 after the Forward Purchase Agreement is awarded. Forward Purchase Agreement 102 may also include terms regarding investment by investors 104.

Forward Purchase Agreement 102 may also include provisions regarding financing capital or other resources upon an innovation meeting the set of criteria for desirable innovation 112. For example, Forward Purchase Agreement 102 may detail an amount of financing capital awarded to an innovator 108 that develops an innovation meeting the set of criteria, either venture or project finance, for the desirable innovation 112. Forward Purchase Agreement 102 may also detail an amount of capital awarded, upon an innovation submission meeting the set of criteria for the desirable innovation 112, to commercialize and scale the innovation. Similarly, Forward Purchase Agreement may detail an amount of resources, such as production capacity/facilities, human capital support, or other resources awarded upon an innovation submission meeting the set of criteria for the desirable innovation 112.

The Forward Purchase Agreement 102 may also include provisions regarding the nature of the relationship of the various stakeholders upon the award of Forward Purchase Agreement 102. For example, upon a submission meeting the set of criteria of desirable innovation 112, the Forward Purchase Agreement 102 may detail that the innovator 108 and the company 106 may establish a joint venture to further develop, commercialize, and scale the desirable innovation 112. In other examples, the Forward Purchase Agreement 102 may detail that the company 106 and the innovator will have a purely commercial relationship, wherein the company 106 purchases a portion or all of a product or service produced by the innovator 108. Forward Purchase Agreement 102 may also, for example, detail that upon an innovation submission meeting the set of criteria of the desirable innovation 112, a financing relationship is formed between the parties, wherein the company 106 and/or the investor 104 provide venture investment funding to the innovator 108 or financing to back the Forward Purchase Agreement 102. These are merely representative examples of the types of Forward Purchase Agreement 102 that may form the core of the advance market commitment system 100, and should not be construed as limiting, as other types of forward purchasing agreements are also contemplated.

Forward Purchase Agreement 102 may contain provisions regarding intellectual property rights of any submissions for desirable innovation 112. In some examples, innovator 108 may retain full intellectual property rights. In other examples, innovator 108 may share intellectual property rights with one or more other stakeholders in the advance market commitment system 100. As described previously, the advance market commitment system 100 may be managed by a managing entity, that drafts and publicizes the Forward Purchase Agreement 102. In such examples, the managing entity may include provisions in the Forward Purchase Agreement 102 that it retains any and/or all intellectual property rights of the submissions for desirable innovation 112. This would allow the managing entity to control any intellectual property rights if the innovator 108 and/or the company 106 later stops operating. The Forward Purchase Agreement 102 also may include a right of first refusal of any intellectual property rights. These are merely representative examples of the types of Forward Purchase Agreement 102 that may form the core of advance market commitment system 100, and should not be construed as limiting, as other types of forward purchasing agreements are also contemplated.

As has been discussed above, the Forward Purchase Agreement 102 may be focused on developing desirable innovation 112. Accordingly, the Forward Purchase Agreement 102 may include a detailed set of criteria of desirable innovation 112 that any innovations submitted by the innovator 108 must meet in order to be awarded the forward contract 102. The set of criteria may permit objective evaluation of any innovations submitted to be awarded the forward contract 102. The set of criteria may be a set of goals or requirements that desirable innovation 112 should ideally meet. The set of criteria may include, for example, design criteria, performance criteria, output criteria, production criteria, efficiency criteria, cost criteria, ease of use criteria, environmental impact criteria, or any other set of design goals or requirements for the desirable innovation 112. The set of criteria for desirable innovation 112 should be drafted with sufficient specificity such that innovators 108 are aware of and understand the set of goals or requirements upon which any innovation submissions will be evaluated. The set of criteria may include a set of objective standards, so that any parties seeking to innovate to meet the criteria may be evaluated objectively. This may help establish a strong basis by which progress and achievement of innovators 108 can be tracked.

The set of criteria for the desirable innovation 112 may be established by various stakeholders. For example, the optional managing entity may establish the set of criteria for the desirable innovation 112. The optional managing entity may publish such set of criteria in a hosted marketplace, such as an online platform, permitting the various stakeholders, including the investors 104, the companies 106, and the innovators 108 to view and evaluate the set of criteria. Additionally, the set of criteria for the desirable innovation 112 may be established by the various stakeholders in the advance market commitment system 100. For example, the investor 104 may establish the set of criteria for the desirable innovation 112. Or the company 106 may establish the set of criteria for the desirable innovation 112. In other examples, multiple stakeholders may collaborate to establish the set of criteria for desirable innovation 112. The company 106 may work with investor 104 and/or the optional managing entity. Alternatively, the investor 104 may work with the company 106 and/or the optional managing entity to establish the set of criteria for the desirable innovation 112.

The Forward Purchase Agreement 102, including the set of criteria for the desirable innovation 112 may be well publicized before innovation begins to ensure that all of the various stakeholders are aware of, and understand, the obligations and terms of the Forward Purchase Agreement 102. Additionally, drafting the Forward Purchase Agreement 102 with specificity will permit transparency and facilitate a more engaged advance market commitment system 100. By defining the desirable innovation 112 with specificity, it permits the innovators 108 to understand with relative precision the goals or requirements that should be met. This additionally permits that the financial supporter, i.e., the investor 104, of the Forward Purchase Agreement 102 to provide venture funding to innovators knowing that a future market will exist and to know with relative precision what they are agreeing to by financially backing the agreement. This may additionally permit the company 106 to also understand with precision its potential commitment, whether through purchase of output, investment of production resources, etc., to the Forward Purchase Agreement 102.

This transparency of the Forward Purchase Agreement 102 will incentivize the various stakeholders to engage in the advance market commitment system 100. Innovators may be attracted to develop, and submit, possible innovations because they may better understand the possible benefits of the contract. This is beneficial to companies, as they will see a possible development opportunity that they might not be able to achieve with in-house development. Doing so can in turn attract investors, as they see a clear market return on their investment, even before desirable innovation is developed or proven practicability, and without knowing which particular innovator will succeed in developing a desirable innovation.

This is in contrast to traditional project innovation. One of the inherent challenges of early-stage investing is that an investor will often not be able to predict who (i.e., which particular inventor, start-up company, etc.) will develop a viable, or market-leading innovation. Accordingly, traditional early-stage investing typically requires an investor to pick a single potential innovator as developing a desirable innovation. However, this is typically difficult to do for investors, as there is often an inability to do a sufficient comparison in a new industry, and it is also often difficult to know what other innovators are developing as there are many new technologies being developed in stealth.

Additionally, traditional capital market mechanisms are not typically structured to generate a broad suite of desirable innovation, or to finance significant innovations, bringing them to commercial scale at the desired speed. For example, in the areas of sustainability and environmental solutions, there is a need to generate innovation at a large scale, but current capital market mechanisms are often unable to facilitate such innovation. Without a clear market, there would be limited financial support, which in turn hampers the development of innovations. Many desirable innovations require large up-front capital investments to fully develop and prove practicability. Such support is difficult to obtain with current capital market mechanisms.

The advance market commitment system 100 may help overcome some of these inherent challenges of early-stage investing and traditional capital market mechanisms by creating a market for an innovative technology, even when the innovative technology has not been invented and/or fully developed yet, by bringing together various stakeholders, including innovators 108, investors 104, and companies 106 interested in the Forward Purchase Agreement 102. The forward Purchase Agreement 102 defines a clear problem sought to be solved, at least in part, by the desirable innovation 112 and attract innovators to develop towards it. In this way, a future market for the desirable innovation can be established through the use of the advance market commitment system 100.

Accordingly, by creating a future market, this scheme permits capital financing. For example, Bridge Project Financing can line up beside the Forward Purchase Agreement 102 and by publicizing the Forward Purchase Agreement 102, innovators can secure capital funding, which will help bring in financial capital earlier to promote innovation projects, helping unlock capital investment not otherwise available with traditional capital market mechanisms.

This permits open innovation, and may help reduce elements of innovation risk for innovators 108. By defining a market for desirable innovation 112 in advance, innovators better understand that there is a guaranteed project finance funding and/or market commitment upon award of the Forward Purchase Agreement 102. This may inherently reduce the risk that is currently present in today's innovation market. Typically, innovators must innovate and then develop the market subsequently. The advance market commitment system 100 instead establishes the market prior to the development of the innovation. By making finance funding available earlier, this may shorten the development time compared to traditional innovation and capital markets.

The advance market commitment system 100 may help reduce risk for investors 104. By creating a market through Forward Purchase Agreement 102, it permits investors to see the commercial viability, and therefore the return on investment, of providing project finance or investing in the desirable innovation 112.

The advance market commitment system 100 may also promote open innovation for companies 106. The advance market commitment system 100 may permit companies to generate innovative solutions from outside of their in-house development circles. It may allow companies to take part in innovation without requiring companies to invest up-front resources to develop the desirable innovation. Instead, companies may engage in helping commercialize and scale the desirable innovation after it has been developed according to the forward contract 102.

The advance market commitment system 100 is a relatively low-cost and minimal operational way for individuals, companies, and/or governments to engage in impact-innovation and demonstrate meaningful action.

By specifying in detail, and contractually agreeing in advance to the types of deals that are often made only after a technology demonstrates practicability, the time from innovation efforts to market commercialization is shortened, and the access to early stage investment capital can be utilized. This may benefit investors by enabling them to invest on industry verticals, i.e., a specialized market that may span multiple industries, instead of investing on a particular innovation group, e.g., a particular startup company, individual inventor, etc. By doing so, this may help mitigate risk through diversification opportunities. This may also benefit innovators by shortening their path to market and minimizing the dilution often associated with scaling up an innovation and taking it to market.

Additionally, by defining the market for desirable innovation 112 through Forward Purchase Agreement 102, advance market commitment system 100 may make investment capital from investor 104 available to innovator 108 earlier than it otherwise would be without a defined market.

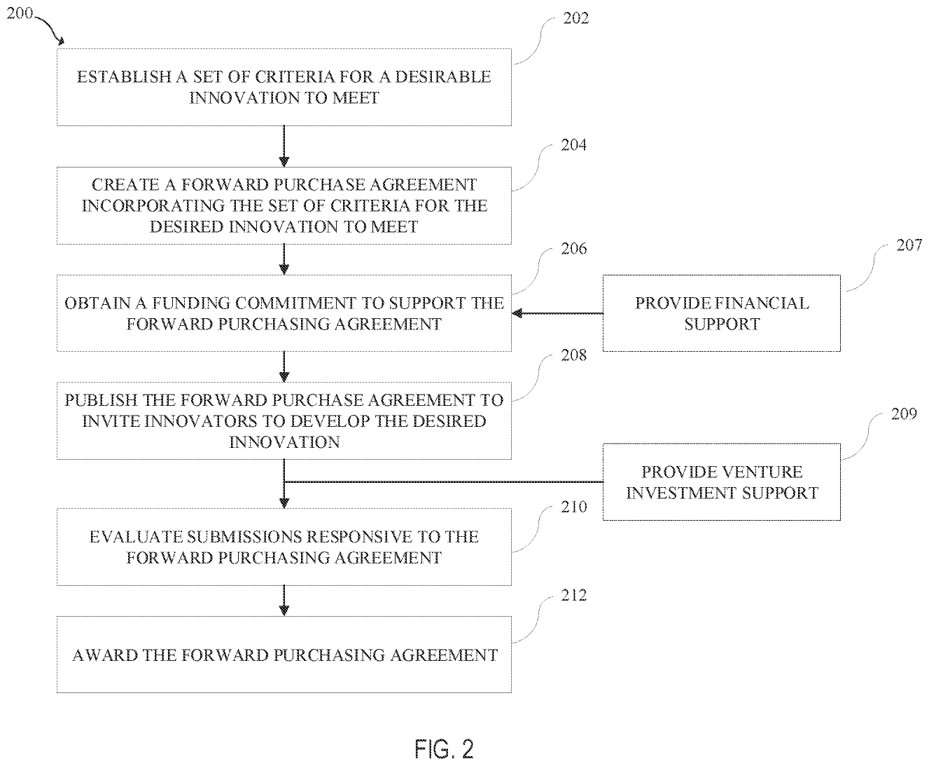

FIG. 2 is an example flow diagram illustrating the process of developing, attracting, and scaling an innovation through the advance market commitment system of FIG. 1. As described with reference to FIG. 1, the advance market commitment system seeks to promote the development of a desirable innovation by defining a market first. Accordingly, at 202, a stakeholder in advance market commitment system establishes a set of criteria for the desirable innovation to meet. The set of criteria may be established by a managing entity, investor, company, or other party seeking a particular desirable innovation. Establishing the set of criteria for the desirable innovation may permit objective standards such that any party seeking to innovate and meet the set of criteria may be evaluated objectively.

A Forward Purchase Agreement incorporating the set of criteria for the desirable innovation may then be drafted and created at 204. This may in effect, begin the innovation process of the advance market commitment system.

To help promote development of the desirable innovation, a funding commitment to support the Forward Purchase Agreement may be obtained at 206. As described with reference to FIG. 1, this funding commitment may be from one or more companies and/or one or more investors seeking the development of the desirable innovation. The funding commitment to support the Forward Purchase Agreement may be obtained from an investor, i.e., financing entity, at the optional 207. The financial support may be in the form of a Bridge Project Financing commitment to back the Forward Purchase Agreement or the financial support may be directly funding innovators. The financial support may also be a combination of direct funding to innovators and financial support of the Forward Purchase Agreement. Enabling the two funding streams may help promote the development of the desirable innovation.

The Forward Purchase Agreement may then be publicized at 208. Publishing the Forward Purchase Agreement permits various stakeholders to view and understand the goals and requirements of the forward purchase agreement. Additionally, it may attract innovators to guide he development of innovations to meet the set of criteria of the desirable innovation. Doing so will attract various stakeholders to participate in the advance market commitment system. In some examples, the Forward Purchase Agreement may be published before obtaining a funding commitment. This may attract various investors and/or companies to participate in the system to fund it, without being aware of the Forward Purchase Agreement prior to publication.

Publication of the Forward Purchase Agreement at 208 may, in effect, begin a period of innovation. This period promotes the development of technologies seeking to meet the set of criteria for the desirable innovation. These developing technologies may be at an early stage, or some that are at later-stage. Accordingly, the publication period of the forward purchase agreement, and thus the period when it is open for submissions, may be a fixed amount of time, such as a certain number of months or years, or may be left open for until certain predetermined conditions are met. For example, the publication period may be open for submissions until a certain number of submissions are received (e.g., one, two, etc.) that meet the set of criteria for the desirable innovation. The publication period may also be open to submissions until some other milestone is met, such as a condition that a third-party not participating in the advance market commitment system develops the desirable innovation independently. The terms of the publication period of the Forward Purchase Agreement may be included in the Forward Purchase Agreement so that various stakeholders know, in advance, when, and for how long, the publication period, and therefore innovation period, is open.

Venture investment may be provided from investors at the optional 209. The venture investment may be directly funding individual innovators, or the venture investment may be pooled in a fund and support a suite of innovators tied to the Forward Purchase agreement.

Throughout the publication and innovation period, various innovators may submit their innovations that they believe meet the set of criteria for the desirable innovation. In order to determine whether the submitted innovations do meet the goals and requirements for the desirable innovation, these responsive submissions to the Forward Purchase Agreement may be evaluated at 210. As described previously with reference to FIG. 1, submissions may be evaluated on an objective set of criteria. This establishes an objective standard upon which progress and achievement can be tracked, and ensures that a submitted innovation meets the goals and requirements of the desired innovation.

In evaluating submissions responsive to the forward purchase agreement, it may be determined that one or more submissions meet the set of criteria for the desirable innovation. Accordingly, the Forward Purchase Agreement may then be awarded to the one or more submissions that meet the standards at 212. In some examples, the Forward Purchase Agreement may be awarded to the innovator or team of innovators that submitted a submission meeting the criteria. In other words, in some examples, the Forward Purchase Agreement may be a “winner-take all” contract, such that there is a single “winner” of the forward purchase agreement. In other examples, awarding of the Forward Purchase Agreement may be a blended outcome. The Forward Purchase Agreement may include modifications such that all valuable submissions are considered, supported, and awarded the forward purchase agreement. In such examples, the Forward Purchase Agreement can promote a suite of innovation, and not necessarily a single innovation. This will help promote a variety of innovations to help solve some of the toughest challenges.

Upon the award of forward purchase agreement, the advance market commitment system includes the optional step of scaling and commercializing the innovation. The scaling and commercializing the innovation may ensure that the submitted innovations are acted upon and brought to market. Bringing the innovation to market ensures that the various stakeholders receive desired returns on any investments in the forward purchase agreement, and ensures that the desired effects of the innovation are more fully realized.

The data flow of the advance market commitment system described above involves private, sensitive, and legally binding information. The various data elements are intended to specify relationship between various entities. As such, protection of these data items from falsification in the advance market commitment system would rely on the trustworthiness of, for example, the managing entity described above. To reduce or remove potential risk for information falsification and to promote trustworthiness, a decentralized and distributed ledger implementation or a blockchain may be used as the underlying data recording, storage, and maintenance of the advanced market commitment system.

In particular a distributed ledger or blockchain system removes the need for a trusted third party. In a blockchain system, data elements are stored as publicly or permissively accessible data units in the form of a chain of data blocks (i.e., a blockchain) having multiple copies distributed to various blockchain nodes. The data integrity in the blockchain system is achieved using digital signature, a consensus mechanism, and other data tampering resistant algorithms.

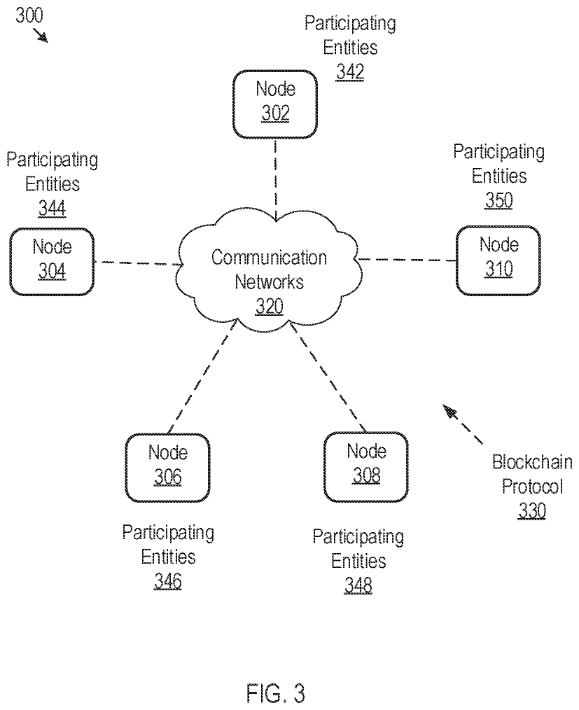

An example of a distributed ledger or blockchain system is shown in FIG. 3. Specifically, FIG. 3 illustrates an example distributed ledger system 300 for secure and decentralized data processing and storage. The distributed ledger system 300 may include decentralized nodes 302, 304, 306, 308, and 310 in communication with each other via a communication network 320. The communication network 320 may be based on, for example, the Internet Protocol (IP), and may include a combination of wired or wireless access networks, local area networks, wide area networks, and other computer networks.

Each node of the system 300 may be a combination of software and hardware for, e.g., storing, maintaining, updating, processing, and querying the secured data (referred to as the blockchain below). Each node may be based on a single computer, a group of centralized or distributed computers, or a single or a group of virtual machines hosed by a cloud computing service provider.

The various nodes may be attributed to the participating entities of the advanced market commitment system above, including but not limited to a plurality of investors, a plurality of innovators, a plurality of innovation-seeking entities (the companies), and one or more managing entities. The managing entities may be responsible for various third-party management functions. Their trustworthiness is inherent in its participation in the blockchain system, like all other entities. The various transactional data and information items stored in the form of distributed ledger are generally unfalsifiable (or in other words, falsified data entries can be detected by the blockchain system with certainty).

The Forward Purchase Agreement described above may be further codified and implemented as an unfalsifiable smart contract in the distributed ledger system. The term “smart contract” is used herein to refer to programs or instructions that are stored in a distributed ledger or blockchain and that execute when predetermined conditions are met. To implemented the Forward Purchase Agreement in the form of a smart contract, the Forward Purchase Agreement may be codified as a set of conditions and a sequence of one or more executable computer instructions and executable data items stored in the distributed ledger triggered by the codified conditions. Each of these executable data elements may be associated with a unique identifier and each section of instructions within an executable data element may further be identified by a section identifier.

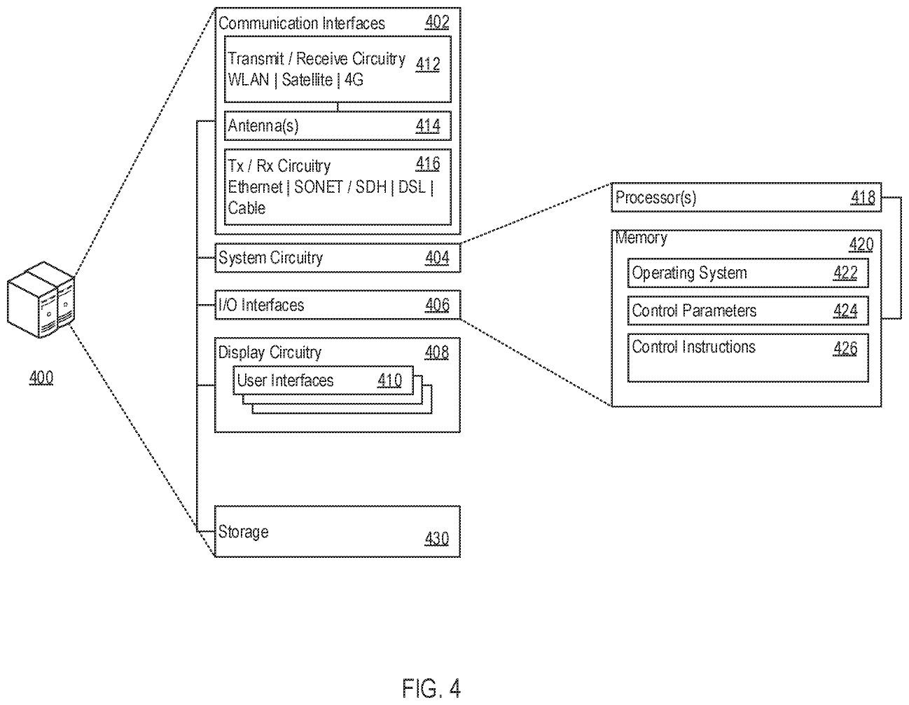

The nodes and computing components above for the advanced market commitment system may be implemented in various manners. FIG. 4 illustrates an exemplary architecture of a computing device 400 on which the various computing components of the system described above. The computing device 400 may include communication interfaces 402, system circuitry 404, input/output (I/O) interface circuitry 406, and display circuitry 408. The graphical user interfaces (GUIs) 410 displayed by the display circuitry 408 may be used to receive user commands/input and to display various outputs. The GUIs 410 may be displayed locally using the display circuitry 408, or for remote visualization, e.g., as HTML, JavaScript, audio, and video output for a web browser running on a local or remote machine.

The GUIs 410 and the I/O interface circuitry 406 may include touch sensitive displays, voice or facial recognition inputs, buttons, switches, speakers and other user interface elements. Additional examples of the I/O interface circuitry 406 includes microphones, video and still image cameras, headset and microphone input/output jacks, Universal Serial Bus (USB) connectors, memory card slots, and other types of inputs. The I/O interface circuitry 406 may further include magnetic or optical media interfaces (e.g., a CDROM or DVD drive), serial and parallel bus interfaces, and keyboard and mouse interfaces.

The communication interfaces 402 may include wireless transmitters and receivers (“transceivers”) 412 and any antennas 414 used by the transmit and receive circuitry of the transceivers 412. The transceivers 412 and antennas 414 may support WiFi network communications, for instance, under any version of IEEE 802.11, e.g., 802.11n or 802.11ac, or other wireless protocols such as Bluetooth, Wi-Fi, WLAN, cellular (4G, LTE/A). The communication interfaces 402 may also include serial interfaces, such as universal serial bus (USB), serial ATA, IEEE 1394, lighting port, I²C, slimBus, or other serial interfaces. The communication interfaces 402 may also include wireline transceivers 416 to support wired communication protocols. The wireline transceivers 416 may provide physical layer interfaces for any of a wide range of communication protocols, such as any type of Ethernet, Gigabit Ethernet, optical networking protocols, data over cable service interface specification (DOCSIS), digital subscriber line (DSL), Synchronous Optical Network (SONET), or other protocol.

The system circuitry 404 may include any combination of hardware, software, firmware, APIs, and/or other circuitry. The system circuitry 404 may be implemented, for example, with one or more systems on a chip (SoC), application specific integrated circuits (ASIC), microprocessors, discrete analog and digital circuits, and other circuitry. The system circuitry 404 may implement any desired functionality of the disclosed system and its various components. As just one example, the system circuitry 404 may include one or more instruction processor 418 and memory 420.

The memory 420 may be implemented as a non-transitory memory circuit and may store, for example, control instructions 422 for implementing the various functions described above, as well as an operating system 421. In one implementation, the processor 418 executes the control instructions 422 and the operating system 421 to carry out any desired functionality of the adaptive federated learning process above.

The computing device 400 may further include various data sources 430, or may be in communication with external data sources. Each of the databases that are included in the data sources 430 may be accessed by the various component of the disclosed system and its components.

An example embodiment, without limitation, of a system including a Forward Purchase Agreement Smart Contract is as follows. A Forward Purchase Agreement Smart Contract may be first be created. As part of the Forward Purchase Agreement Smart Contract, the company agrees to be the guaranteed buyer when the set of criteria for the desirable innovation of the Forward Purchase Agreement Smart Contract are met. The creation of the Forward Purchase Agreement Smart Contract may then electronically trigger a Bridge Project Finance Smart Contract. The Bridge Project Finance Smart Contract guarantees that financing is available for the construction and commercialization of the desirable innovation when the set of criteria for the desirable innovation are met. The Bridge Project Finance Smart Contract is financial backing for the Forward Purchase Agreement Smart Contract and may benefit the company by removing any obligation of the company to commit its financial or other resources up-front to finance the conception and/or development of the desirable innovation.

Once the Forward Purchase Agreement Smart Contract has been created and the Bridge Project Finance Smart Contract is triggered, the system may search databases worldwide of investors and project finance providers to participate in providing financing support to the Bridge Project Finance Smart Contract. The system may additionally search databases worldwide to identify innovators and development networks to communicate about the Forward Purchase Agreement to invite the participation of the innovators and development networks. The system may additionally search databases worldwide for investors, including venture capitalists, private equity investors, companies, universities, and/or foundations, to identify investors potentially interested in providing financial support for desirable innovations that are developed during the innovation period of the Forward Purchase Agreement Smart Contract. The system may then publish, i.e., announce, the Forward Purchase Agreement Smart Contract and the Bridge Project Finance Smart Contract, permitting innovators to view and understand that a market and financial is available for them to target through the development of the desirable innovation. The system may also publish, i.e., announce, the Forward Purchase Agreement Smart Contract and the Bridge Project Finance Smart Contract to the investors, communicating that a new market is being established. This may indicate to the investors that innovation will emerge as a result of the Forward Purchase Agreement Smart Contract, and that the possible investment in the development of desirable innovations has been financially de-risked.

In this way, the Forward Purchase Agreement Smart Contract and the Bridge Project Finance Smart Contract may enable an overall innovation system, for example, the advance market commitment system. The Forward Purchase Agreement Smart Contract and the Bridge Project Finance Smart Contract support innovators by providing them a specific set of criteria for the desirable innovation to meet, and provide a future market and guaranteed project financing. The system also may lower the risk for early-stage investment capital, enabling financial support for innovators, to help support the innovation process.

Another example embodiment, without limitation, may be as follows. The Forward Purchase Agreement may be placed in a decentralized autonomous organization (DAO). By placing the Forward Purchase Agreement into a DAO, innovators may view, understand, and respond to the call for innovation from anywhere it the world. This may also enable individuals and/or investors to participate in the DAO by purchasing tokens to support the Forward Purchase Agreement and obtaining voting rights to choose which innovation submissions to the original Forward Purchase Agreement, and potentially subsequent Forward Purchase Agreements that are tied to the original, should be awarded the contract. The innovations chosen through the DAO may receive optional financial support from the DAO participants, opening up additional opportunities for financial, logistical, and other support for the development, scaling, and commercialization of the desirable innovation. The use of a DAO to secure venture funding enables individual investors to participate and contribute investment capital and other resources towards the development of innovations, including a broad suite of innovation, tied to a specific Forward Purchase Agreement.

The method and system described herein may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein may be employed.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

Many other modifications of the implementations above may be made to adapt a particular situation or material to the teachings without departing from the scope of the current disclosure. Therefore, it is intended that the present methods and systems not be limited to the particular embodiments disclosed, but that the disclosed methods and systems include all embodiments falling within the scope of the appended claims.

1. A secure distributed computing and storage system, comprising memories for storing computer instructions and processors in communication with the memories, the processors and the memories being arranged as a plurality of computing nodes in a secure distributed ledger platform, the processors, when executing the computer instructions, being configured to:
receive a call for innovation with predefined technological and market goals from a commercialization entity;
receive proposals of innovations to the call for innovation from a plurality of innovators;
receive responses from at least one investing entity for financial and logistical support for commercialization of the proposals of innovations;
select at least one proposed innovation associated with at least one target innovator;
form a forward purchase agreement between the commercialization entity, the at least one target innovator, and the at least one investing entity, the forward purchase agreement specifying future obligations of the commercialization entity and the at least one investing entity when the proposed innovation meets the predefined technological and market goals in a future time; and
codify the forward purchase agreement as a smart contract for storage and future execution in the secure distributed ledger platform.

2. The secure distributed computing and storage system of claim 1, the processors being further configured to:
evaluate whether the at least one proposed innovation meets the predefined technological and market goals of the call for innovation.

3. The secure distributed computing and storage system of claim 1, the processors being further configured to publish the call for innovation to invite the proposals of innovations.

4. The secure distributed computing and storage system of claim 1, the processors being further configured to publish the proposals of innovations to permit the commercialization entity to review.

5. The secure distributed computing and storage system of claim 1, the processors being further configured to publish the forward purchase agreement.

6. The secure distributed computing and storage system of claim 1, wherein the forward purchase agreement comprises an offtake agreement specifying a future purchase of the proposed innovation.

7. The secure distributed computing and storage system of claim 1, wherein the forward purchase agreement further specifies present obligations of the commercialization entity.

8. The secure distributed computing and storage system of claim 7, wherein the present obligations of the forward purchase agreement comprise a time period to remain open for receiving the proposals of innovations.

9. The secure distributed computing and storage system of claim 7, wherein the present obligations of the forward purchase agreement comprise a period open for receiving the responses from the at least one investing entity.

10. The secure distributed computing and storage system of claim 7, wherein the present obligations of the forward purchase agreement specify a funding obligation of the at least one investing entity.

11. The secure distributed computing and storage system of claim 1, wherein the future obligations of the forward purchase agreement specify a commercialization obligation of the commercialization entity.

12. The secure distributed computing and storage system of claim 11, wherein the commercialization obligation comprises a commitment of production resources of the commercialization entity.

13. The secure distributed computing and storage system of claim 11, wherein the commercialization obligation comprises a commitment of production resources of the commercialization entity.

14. The secure distributed computing and storage system of claim 11, wherein the commercialization obligation comprises a commitment of human capital resources of the commercialization entity.

15. The secure distributed computing and storage system of claim 1, the processors being further configured to distribute the financial and logistical support of the at least one investing entity for the commercialization of the at least one proposed innovation.
